(19) United States
(12) Patent Application Publication
(10) Pub. No.: US 2026/0311491 A1
(43) Pub. Date: Oct. 8, 2026

(54) SYSTEM AND METHOD FOR ADAPTIVE CALIBRATION FOR AUTONOMOUS DRIVING

(71) Applicants: Hyundai Motor Company, Seoul (KR); Kia Corporation, Seoul (KR)

(72) Inventors: Joo Hyun LEE, Hwaseong-Si (KR); Hyeon Jun LIM, Hwaseong-Si (KR)

(21) Appl. No.: 19/409,994

(22) Filed: Dec. 5, 2025

(30) Foreign Application Priority Data
Apr. 2, 2025 (KR) 10-2025-0042965

(51) Int. Cl. G06V 20/56; B60W 60/00

(52) U.S. Cl. CPC G06V 20/56; B60W 60/001; B60W 2756/10

(57) ABSTRACT

Disclosed is a method and an apparatus for recognizing an object. An apparatus of a vehicle may be configured to receive, from a sensor of the vehicle, sensor data associated with an object that is present in a surrounding environment of the vehicle; receive, from the vehicle a set of parameters for calibrating a coordinate system for object recognition, and information about a resource state of a processor or a memory; determine, based on driving environment information and motion information of the vehicle, a motion score and a confidence score; adjust the confidence score based on a result of segmenting the sensor data and a result of recognizing the object; execute, based on the adjusted confidence score, online calibration of the coordinate system for object recognition; and control, based on the calibrated coordinate system for object recognition, an autonomous driving operation of the vehicle.

### CROSS-REFERENCE TO RELATED APPLICATION

This application claims the benefit of and priority to Korean Patent Application No. 10-2025-0042965, filed in the Korean Intellectual Property Office on Apr. 2, 2025, the entire contents of which are incorporated herein by reference.

### TECHNICAL FIELD

The present disclosure relates to autonomous vehicles, and more particularly to a system and a method for recognizing an object based on an artificial intelligence.

### BACKGROUND

With the development and commercialization of autonomous vehicles, there has been an increase in the number and variety of sensors being adopted in vehicles as well as the use of artificial intelligence (AI) technology to implement an autonomous driving function of the vehicle. For example, much research is being done on recognition technology for identifying objects that are present in front of a moving vehicle, determining how far those objects are located from the vehicle, and what algorithm the vehicle should use to respond to specific situations to ensure safety of its occupants.

Thus, a vehicle sensor technology has become more advanced. There is a trend towards implementing high-performance sensors in vehicles, such as light detection and ranging (LiDAR) sensors for recognizing a surrounding environment using laser beams, radar sensors using radio waves, ultrasonic sensors, fisheye cameras capable of capturing 360-degree images, multifocal lenses, and global positioning systems (GPS).

It may be possible to aggregate the measured results obtained from the plurality of sensors and sensor types to implement a so-called super sensor vehicle. The concept of a super sensor in self-driving or autonomous vehicles refers to a technology for combining measured values of various sensors and sensor types to more accurately recognize a surrounding environment of the vehicle to improve driver convenience and safety, rather than relying on and analyzing individual sensor measurements separately. With the advent of information and communications technology (ICT) and cloud technology, the sensors used for autonomous driving and AI algorithms associated with it have become more advanced than ever. For example, rather than utilizing data gathered from a single vehicle, data may be collected remotely from a fleet of vehicles, and the data that is accumulated in this manner may be used to train an AI server and a database to increase the reliability and accuracy of the vehicle sensor.

The matters described in this Background section are only for enhancement of understanding of the background of the disclosure, and should not be taken as acknowledgement that they correspond to prior art already known to those skilled in the art.

### SUMMARY

The present disclosure has been made to solve problems occurring in at least some implementations while advantages achieved by those implementations are maintained intact.

An aspect of the present disclosure provides a system and a method for recognizing an object based on an artificial intelligence (AI) autonomous driving sensor and analyzing a driving environment, and more particularly, provides a calibration system for autonomous driving for adaptively adjusting a calibration parameter to selectively apply a calibration mode most suitable for a current road and a method therefor.

The technical problems to be solved by the present disclosure are not limited to the aforementioned problems, and any other technical problems not mentioned herein will be clearly understood from the following description by those skilled in the art to which the present disclosure pertains.

The present disclosure may be implemented in the following various aspects to address all or at least some of the above-mentioned technical problems.

According to one or more example embodiments of the present disclosure, an apparatus of a vehicle may include: a processor; and a memory storing at least one instruction that is configured, when executed by the processor, to cause the apparatus to: receive, from a sensor of the vehicle, sensor data associated with an object that is present in a surrounding environment of the vehicle; store, in the memory, the sensor data; receive, from the vehicle: a set of parameters for calibrating a coordinate system for object recognition, and information about a resource state of at least one of the processor or the memory; determine, based on driving environment information and motion information of the vehicle, a motion score and a confidence score; adjust the confidence score based on a result of segmenting the sensor data and a result of recognizing the object; execute, based on the adjusted confidence score, online calibration of the coordinate system for object recognition; and control, based on the calibrated coordinate system for object recognition, autonomous driving operation of the vehicle.

The least one instruction may be configured, when executed by the processor, to cause the apparatus to adjust the confidence score by: segmenting the sensor data based on the driving environment information and the motion information.

The least one instruction may be configured, when executed by the processor, to cause the apparatus to adjust the confidence score by: recognizing the object based on the driving environment information and the motion information.

The least one instruction may be configured, when executed by the processor, to further cause the apparatus to: receive, via a global positioning system (GPS) or a navigation device in the vehicle, the driving environment information.

The least one instruction may be configured, when executed by the processor, to further cause the apparatus to determine whether to execute the online calibration by entering a waiting state without executing the online calibration, based on the resource state being less than a reference value.

The least one instruction may be configured, when executed by the processor, to further cause the apparatus to: determine the motion score based on a proportional relationship or an inverse proportional relationship between the driving environment information and the motion information.

The least one instruction may be configured, when executed by the processor, to further cause the apparatus to determine whether to execute the online calibration by: entering a waiting state without executing the online calibration, based on the motion score being less than a reference value.

The least one instruction may be configured, when executed by the processor, to further cause the apparatus to determine whether to execute the online calibration by: entering a waiting state without executing the online calibration, based on the confidence score being less than a reference value.

The least one instruction may be configured, when executed by the processor, to cause the apparatus to execute the online calibration by: storing, in a buffer of the memory, an online calibration parameter and an online calibration confidence score that are obtained for the online calibration.

The least one instruction may be configured, when executed by the processor, to cause the apparatus to execute the online calibration by: updating, based on the buffer being full, a parameter value associated with the buffer to empty the buffer.

According to one or more example embodiments of the present disclosure, a method performed by an apparatus of a vehicle may include: receiving, from a sensor of the vehicle, sensor data associated with an object t present in a surrounding environment of the vehicle; receiving, from the vehicle, a set of parameters for calibrating a coordinate system for object recognition, and information about a resource state of at least one of a processor of the vehicle or a memory of the vehicle; determining, based on driving environment information and motion information of the vehicle, a motion score and a confidence score; adjusting the confidence score based on a result of segmenting the sensor data and a result of recognizing the object; executing, based on the adjusted confidence score, online calibration of the coordinate system for object recognition; and controlling, based on the calibrated coordinate system for object recognition, an autonomous driving operation of the vehicle.

Adjusting the confidence score may include: segmenting the sensor data based on the driving environment information and the motion information.

Adjusting the confidence score may include: recognizing the object based on the driving environment information and the motion information.

The method may further include: receiving, via a global positioning system (GPS) or a navigation device in the vehicle, the driving environment information.

The method may further include determining whether to execute the online calibration by: entering a waiting state without executing the online calibration, based on the resource state being less than a reference value.

The method may further include: determining the motion score based on a proportional relationship or an inverse proportional relationship between the driving environment information and the motion information.

The method may further include determining whether to execute the online calibration by: entering a waiting state without executing the online calibration, based on the motion score being less than a reference value.

The method may further include determining whether to execute the online calibration by: entering a waiting state without executing the online calibration, based on the confidence score being less than a reference value.

Executing the online calibration may include: storing, in a buffer of the memory, an online calibration parameter and an online calibration confidence score that are obtained for the online calibration.

Executing the online calibration may include: updating, based on the buffer being full, a parameter value associated with the buffer to empty the buffer.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example system for controlling a vehicle to automatically recognize an object and perform autonomous driving;

FIG. 2 is a flow diagram illustrating an example operation process of an autonomous driving system with LiDAR recognition software architecture;

FIG. 3 is a flow diagram illustrating an example algorithm for applying a calibration technology of a LiDAR sensor to an autonomous driving LiDAR recognition software architecture;

FIG. 4 is a flow diagram on a calibration part of an example algorithm for applying a calibration technology of a LiDAR sensor to an autonomous driving LiDAR recognition software architecture;

FIG. 5 is a flowchart illustrating an example process of performing calibration management;

FIG. 6 is a flowchart illustrating an example process of updating a static calibration value;

FIG. 7 is a block diagram illustrating an example process of verifying calibration and evaluating the result in real time; and

FIG. 8 is a block diagram illustrating an example computing system for autonomous vehicle control and object recognition computation according to an embodiment of the present disclosure.

### DETAILED DESCRIPTION

Hereinafter, one or more example embodiments of the present disclosure will be described in detail with reference to the drawings. In adding the reference numerals to the components of each drawing, it should be noted that the identical component is designated by the identical numerals even when they are displayed on other drawings. Further, in describing the example embodiment(s) of the present disclosure, a detailed description of well-known features or functions will be ruled out in order not to unnecessarily obscure the gist of the present disclosure.

In describing components of example embodiment(s) of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., adaptive LiDAR calibration) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., adaptive LiDAR calibration) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., adaptive LiDAR calibration) described herein.

Minimum risk maneuver (MRM) operation(s) may also be controlled, for example, based on one or more features (e.g., adaptive LiDAR calibration) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., adaptive LiDAR calibration) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., adaptive LiDAR calibration) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., adaptive LiDAR calibration) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., adaptive LiDAR calibration) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

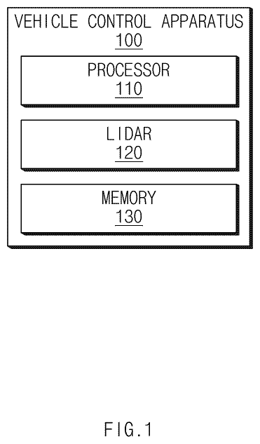

FIG. 1 is a block diagram illustrating an example system for controlling a vehicle to automatically recognize an object and perform autonomous driving.

Referring to FIG. 1, a vehicle control apparatus 100 may be implemented inside or outside a vehicle and some of the components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

The vehicle control apparatus 100 may include a processor 110, light detection and ranging (LiDAR) 120, and a memory 130. The processor 110, the LiDAR 120, and the memory 130 may be electronically or operably coupled with each other by an electronical component including a communication bus.

Hereinafter, that pieces of hardware are operably coupled with each other may include that a direct connection or an indirect connection between the pieces of hardware is established wired and/or wirelessly, such that second hardware is controlled by first hardware among the pieces of hardware.

The different blocks are illustrated, but the present disclosure is not limited thereto. For example, some of the pieces of hardware of FIG. 1 may be included in a single integrated circuit including a system on a chip (SoC). Types of the pieces of hardware included in the vehicle control apparatus 100 and/or the number of the pieces of hardware are/is not limited to those shown in FIG. 1. For example, the vehicle control apparatus 100 may include only some of the pieces of hardware shown in FIG. 1.

The vehicle control apparatus 100 may include hardware for processing data based on one or more instructions. For example, the hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa-core, or an octa core.

The processor 110 may include at least one of a graphic processing unit (GPU) or a neural processing unit (NPU), or any combination thereof. For example, the GPU may be referred to as a visual processing unit (VPU). For example, the NPU may be referred to as a neural network processing unit.

The vehicle control apparatus 100 may include a depth sensor for detecting an external object. For example, the depth sensor for detecting the external object may include at least one of a time of flight (ToF) sensor, the LiDAR 120, a structured light sensor, an ultrasonic sensor, an infrared sensor, radio detection and ranging (RADAR), or an optical distance sensor, or any combination thereof. Hereinafter, a description will be given of LiDAR for convenience of description.

The vehicle control apparatus 100 may include the LiDAR 120 for obtaining a plurality of points based on a pulse laser signal. For example, the LiDAR 120 may obtain datasets for identifying a surrounding thing around the vehicle control apparatus 100 (or the vehicle including the vehicle control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing to return.

For example, the LiDAR 120 may obtain datasets representing an external object in a space formed by an x-axis, a y-axis, and a z-axis, based on the pulse laser signal reflected from the surrounding thing. For example, the LiDAR 120 may obtain datasets including a plurality of points in the space formed by the x-axis, the y-axis, and the z-axis, based on receiving the pulse laser signal at a specified period. For example, the plurality of points may include points representing the external object in a three-dimensional (3D) virtual coordinate system. The 3D virtual coordinate system may include at least one of a vehicle coordinate system or a LiDAR coordinate system, or any combination thereof. However, the example of the 3D virtual coordinate system is not limited to those described above.

The memory 130 of the vehicle control apparatus 100 may include a hardware component for storing data and/or an instruction input and/or output from the processor 110 of the vehicle control apparatus 100. For example, the memory 130 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

One or more instructions indicating computation and/or an operation to be performed using data by the processor 110 of the vehicle control apparatus 100 may be stored in the memory 130 of the vehicle control apparatus 100. A set of the one or more instructions may be referred to as a program, firmware, an operating system, process, a routine, a sub-routine, and/or an application.

Hereinafter, that the application is installed in the vehicle control apparatus 100 may mean that one or more instructions provided in the form of the application are stored in the memory 130, which may mean that the one or more applications are stored in a format executable by the processor 110 of the vehicle control apparatus 100 (e.g., as a file with an extension specified by the operating system of the vehicle control apparatus 100).

For example, the memory 130 may include a first neural network model for detecting an object. For example, the memory 130 may include a second neural network model for outputting a type of the plurality of points obtained by the LiDAR 120 and/or a score of the plurality of points.

The processor 110 may obtain at least one of a first virtual box for representing a target object or a first class indicating a type of the target object, or any combination thereof, based on the plurality of points obtained via the LiDAR 120 and the first neural network model stored in the memory 130.

The processor 110 may obtain at least one of the first virtual box for representing the target object or the first class indicating the type of the target object, or any combination thereof, based on inputting the plurality of points to the first neural network model. For example, the first neural network model may include an object detection model. For example, the target object may include an external object located within a specified distance from the vehicle control apparatus 100 (or a host vehicle including the vehicle control apparatus 100). For example, the target object may include an object which is identified by the vehicle control apparatus 100 and is continuously tracked. For example, the type of the target object may include a plurality of types for classifying the target object. For example, the type of the target object may include at least one of a first type indicating the ground or a second type indicating a type different from the ground, or any combination thereof. However, the type of the target object is not limited to those described above. For example, the type of the target object may include, but is not limited to, at least one of a third type indicating a person or a fourth type indicating a vehicle, or any combination thereof.

The processor 110 may obtain at least one of first partial points corresponding to at least a portion of the target object among the plurality of points, based on the plurality of points and the second neural network model or a second class identified via the first partial points and indicating the type of the target object, or any combination thereof, based on the plurality of points and the second neural network model. For example, the second neural network model may include a segmentation model.

For example, the second neural network model may include a neural network model for obtaining the type of the plurality of points and the score of the plurality of points.

For example, the processor 110 may obtain the first partial points corresponding to the at least a portion of the target object among the plurality of points, based on inputting the plurality of points to the second neural network model. For example, the processor 110 may identify the type of the plurality of points, based on inputting the plurality of points to the second neural network model. For example, the processor 110 may obtain the first partial points corresponding to the at least a portion of the target object among the plurality of points, based on the type of each of the plurality of points.

The processor 110 may perform a first specified algorithm for the plurality of points. For example, the processor 110 may perform the first specified algorithm for classifying the type of each of the plurality of points, for the plurality of points. For example, the processor 110 may classify second partial points corresponding to a specified type among the plurality of points. For example, the specified type may include a type representing the ground.

For example, the processor 110 may classify the second partial points corresponding to the specified type, based on performing the first specified algorithm for the plurality of points, and may exclude the second partial points from the plurality of points to obtain (or identify) the first partial points.

The processor 110 may obtain at least one of a partial class for obtaining the second class, or the score of each of the plurality of points, or any combination thereof, based on inputting the plurality of points to the second neural network model. For example, the processor 110 may obtain the partial class and the score of each of the plurality of points, based on inputting the plurality of points to the second neural network model. For example, the partial class may include classifying each of the plurality of points as any type.

For example, the processor 110 may fuse the partial class, the score of each of the plurality of points, and the second partial points. For example, the processor 110 may perform clustering, based on fusing the partial class, the score of each of the plurality of points, and the second partial points. For example, the clustering may include grouping the first partial points corresponding to the at least a portion of the target object.

For example, the processor 110 may obtain a point cloud for generating a second virtual box, based on the first partial points. For example, the processor 110 may obtain the point cloud, based on grouping the first partial points.

For example, the processor 110 may generate the second virtual box which is different from the first virtual box and is for representing the target object, based on the point cloud. For example, the second virtual box may include a box including at least some of the first partial points.

For example, the processor 110 may identify a heading direction indicating a progress direction of the target object, based on at least one of the first partial points or the point cloud, or any combination thereof.

For example, the processor 110 may identify a position of the second virtual box on the virtual coordinate system, based on the at least one of the first partial points or the point cloud, or any combination thereof. For example, the processor 110 may identify a size of the second virtual box, based on the at least one of the first partial points or the point cloud, or any combination thereof. For example, the processor 110 may identify a second class, based on the at least one of the first partial points or the point cloud, or any combination thereof. For example, the processor 110 may identify at least one of the heading direction indicating the progress direction of the target object, the position of the second virtual box on the virtual coordinate system, the size of the second virtual box, or the second class, or any combination thereof, based on the at least one of the first partial points or the point cloud, or the any combination thereof. For example, the processor 110 may identify a heading direction of a bounding box, based on at least one of the first virtual box, the first class, the heading direction of the second virtual box, the position of the second virtual box, the size of the second virtual box, or the second class, or any combination thereof. For example, the processor 110 may identify a position of the bounding box on the virtual coordinate system, based on the at least one of the first virtual box, the first class, the heading direction of the second virtual box, the position of the second virtual box, the size of the second virtual box, or the second class, or the any combination thereof. For example, the processor 110 may obtain a third class indicating the type of the target object corresponding to the bounding box, based on the at least one of the first virtual box, the first class, the heading direction of the second virtual box, the position of the second virtual box, the size of the second virtual box, or the second class, or the any combination thereof. For example, the processor 110 may obtain at least one of the heading direction of the bounding box, the position of the bounding box on the virtual coordinate system, or the third class indicating the type of the target object corresponding to the bounding box, or any combination thereof, based on the at least one of the first virtual box, the first class, the heading direction of the second virtual box, the position of the second virtual box, the size of the second virtual box, or the second class, or the any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box using the second identifier. For example, the processor 110 may track the target object, based on identifying a plurality of bounding boxes including the bounding box to which the second identifier is assigned, at a plurality of frames. For example, because the second identifier is an identifier assigned to the bounding box corresponding to the target object, the processor 110 may identify the plurality of bounding boxes to which the second identifier is assigned, at the plurality of frames, to track the target object.

The processor 110 may output the bounding box corresponding to the target object, based on at least one of the first virtual box, the first class, the first partial points, or the second class, or any combination thereof. For example, the bounding box may include an example of representing the target object on the virtual coordinate system in the form of a hexahedron.

Hereinafter, a description will be given briefly of operations performed by the CPU, the GPU, and/or the NPU included in the processor 110.

The processor 110 may include at least one of the CPU, the GPU, or the NPU, or any combination thereof. For example, at least one of the GPU or the NPU, or any combination thereof may obtain the first virtual box and the first class, based on the first neural network model. For example, at least one of the GPU or the NPU may obtain the first virtual box and the first class. For example, the at least one of the GPU or the NPU, or the any combination thereof may obtain the partial class for obtaining the second class and the score of each of the plurality of points, based on the second neural network model. For example, the at least one of the GPU or the NPU may obtain the partial class for obtaining the second class and the score of each of the plurality of points, based on the second neural network model. For example, the CPU may classify the second partial points corresponding to the specified type among the plurality of points, based on performing the first specified algorithm for classifying the type of each of the plurality of points, for the plurality of points.

As described above, the vehicle control apparatus 100 may include the at least one processor 110. The vehicle control apparatus 100 may detect the target object using the at least one processor 110 to accurately detect the target object. Furthermore, by performing a parallel process, the vehicle control apparatus 100 may reduce a load for each processor.

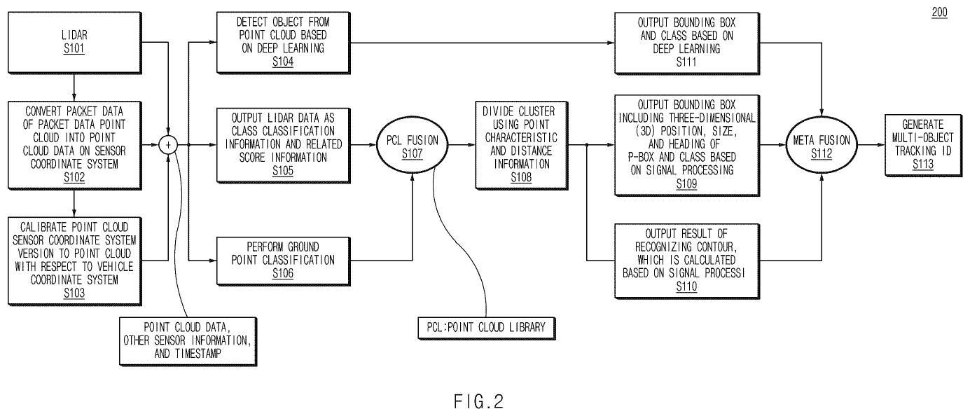

Meanwhile, before seeing FIG. 2, an object recognition-related description based on LiDAR is added for the overall understanding of AI object recognition according to the present disclosure as follows.

An object recognition process by the LiDAR 120 or the AI module passes through three steps, such as pre-processing, segmentation, and tracking.

An object recognition system 1000 according to the present disclosure may pass through pre-processing before executing an object recognition function. The pre-processing may include, for example, an operation of removing points forming the ground, based on laser sensing data (e.g., raw data) input from the LiDAR 120. Because it is able to be misrecognized as if there is any object on the ground by a laser beam reflected from the ground, the process of separating the ground from a thing which is not the ground may be performed in the pre-processing step and may also be performed in the segmentation step if necessary.

For example, the pre-processing in AI object recognition is understood as a process in which an image processing tool of the AI module in the processor 110 removes noise of a LiDAR point cloud image, for example, reduces the total number of points which are present in the LiDAR point cloud image via a voxel downsampling technique or the like to promote computational efficiency.

For reference, the LiDAR point cloud image may be displayed in a bird's eye view (BEV) scheme. If a LiDAR map is generated as if it were a bird's eye view of the city while the bird flies in the sky, this is referred to as a BEV image.

In other words, as described above, the LiDAR 120 transmits a laser beam to a surrounding environment and records a time when the laser beam is reflected from an object which is present in the outside to return, thus generating a point every many laser signals and calculating a distance to the point. By repeatedly transmitting many laser beams, the processor 110 may generate a real-time LiDAR map for the surrounding environment as a BEV type of 3D map and may generate the real-time LiDAR map as a two-dimensional (2D) map if necessary.

The line or surface shown in black and white on the LiDAR point cloud map is actually composed of innumerable points (each of which is generated by the laser beam of the LiDAR 120). Due to this, a LiDAR sensing image is called a LIDAR point cloud image. Of course, for example, if a red, green, blue-depth (RGB-D) sensor and the LiDAR sensor are combined with each other, the LiDAR point cloud image may be re-implemented in color.

If it is difficult for humans to recognize a thing using only one of many points in the LiDAR point cloud image, but, for example, if they synthetically look at the point cloud from the BEV's point of view or in the same way as a 2D floor plan, they may roughly guess whether the surrounding environment around the vehicle which is currently performing autonomous driving is any shape. In addition, for example, it is possible to recognize a vehicle, a bus, a pedestrian, a street tree, a traffic sign, or the like which is present in the LiDAR point cloud image. Such a thing or person is called an object in an AI image recognition technology. It is possible to classify the object as a class which belongs to a group of the specific nature, such as a vehicle class or a bus class.

The help of a deep AI neural network is required to classify whether any object in the LiDAR point cloud image is the vehicle class or the bus class. AI training should precede to find objects in the LiDAR point cloud image via the AI neural network and identify a class of the object.

For example, a dataset (source: https://pandaset.org/#data-collection) called PANDASET™ includes more than 48,000 camera images (images captured primarily in the Silicon Valley region of the United States) and includes more than 16,000 LiDAR scam images. A total of 28 classes, such as pedestrians, cars, bicycles, construction site signs, and traffic signs, are arranged in the form of an annotation in these images.

Furthermore, the LiDAR point cloud image may be visualized to suit an option desired by the user using a point cloud working tool, such as Open3D™ (source: https://www.open3d.org/). Because the LiDAR 120 is able to detect a distance, it may more realistically reproduce a 3D LiDAR image in such a manner as to display a thing in a long distance in, for example, a deep blue and display a thing in a short distance in a light blue, when the LiDAR point cloud image is visually processed using, for example, Open3D™.

In addition, as described above, the technology, for example, voxel (3D pixel) downsampling, may be applied to the LiDAR point cloud image to pre-process an original LiDAR image (e.g., raw data). Herein, the voxel refers to a 3D pixel in the shape of a regular hexahedron and the voxel downsampling is a technology for reducing the number of points not to require excessive AI computation, even while maintaining a structure of various objects included in the LiDAR point cloud.

Meanwhile, the LiDAR 120 radiates, for example, m laser beams n times during one scan cycle. In this case, the scan value of the laser beam which collides with an external object to return constitutes an (m×n) matrix. This (m×n) matrix data is called a range image. Each point constituting the LiDAR point cloud image may include depth (e.g., range) information and may further include intensity, an azimuth, an inclination, or the other additional information of the returned laser pulse. The range image is a large amount of datasets, for example, Waymo™ open dataset (WOD). It is possible to perform AI learning of the range image.

A range view (RV) refers to a technique for converting a 3D point cloud into a 2D scene, for example, a 2.5D scene to represent the 3D point cloud as a 3D LiDAR map that humans are able to intuitively understand, like an analog picture, rather than a large number of points. The 3D LiDAR point cloud image has 2D coordinates in the range view image, but the 3D laser-related information (e.g., the angle, the inclination, the intensity, and the like) which is recorded when previously obtaining the range image is not discarded. If a variable called a width is applied to (x, y) coordinates among (x, y, z) coordinate values of the 3D LiDAR image to obtain a coordinate on one axis in two dimensions and range image information indicating a range (depth) and a variable called a height are applied to the (z) coordinate to obtain a coordinate of the other axis in two dimensions, this is generated as a 2D range view image.

In addition, the AI algorithm according to the present disclosure may include a convolutional neural network (CNN). The CNN is an AI training module frequently used to extract a feature (or a feature point) from image data. To this end, there is a dataset composed of tens of thousands of commercially available images. The CNN currently has a version capable of processing each of one-dimensional to three-dimensional images. In other words, the result of a range view image processing tool is learned by the CNN to perform a function of helping AI to accurately recognize an object in an image.

Because a thing present around an autonomous vehicle is finally recognized by a machine, the operation of generating a ground truth (GT) bounding box on the above-mentioned LiDAR map is also an important process in object recognition. Ground truth (GT) in machine learning is a term used when indicating an original value and a real value of data AI wants to learn. It may be usually viewed as a kind of image annotation overlaid on the LiDAR point cloud image as a bounding box with a box-shaped boundary.

In other words, the AI module fetches a label to group various objects to recognize the object. Of course, an interval of 3D data points used to output a GT bounding box may be set, which may be set such that about 50 to 1000 LiDAR point cloud points are included in one GT bounding box.

Of course, there is no GT annotation in original data (or raw data) captured by the sensor, such as the LiDAR 120, while the vehicle is driving. The processor 110 should recognize a target which belongs to various classes, such as a road sign of the road, a crosswalk, a pedestrian, the other vehicle, and a center line, as an object. The GT annotation is a means used to compare the result of determining the object recognized by the AI algorithm of the processor 110 with the reality to measure an error in object recognition and evaluate AI performance sometimes. A GT bounding box overlaid on the original image in the form of an annotation may be set manually by the user, but there is representatively a commercially available GT computation tool, such as grid-striding.

Meanwhile, if the AI object recognition module is driven, a predicted bounding box may be checked. The result of being recognized as an object of a specific class by the processor 110 from the original image data obtained from the LiDAR 120 or the like is represented in the form of another bounding box similar to the GT bounding box. Unlike the GT bounding box, the predicted bounding boxes are the result of being calculated by autonomous driving AI. The predicted bounding box may be identical to the GT bounding box, but may fail to be identical to the GT bounding box or may not at all have a region where the predicted bounding box and the GT bounding box overlap with each other.

For reference, because it is unable to conclude that an object of a specific class is actually present at a certain position definitely using only predicted bounding boxes, the predicted bounding boxes are usually called probability boxes (P-Boxes) or predicted bounding boxes.

Segmentation processing performed after the pre-processing refers to displaying a specific portion (e.g., traffic lights) of the road in, for example, red and displaying the rest (bituminous road) in blue. Clustering the point cloud into a certain group and generating a P-Box may be performed in the segmentation step. For reference, there is a technology called cluster expansion. Herein, an expansion target may include a cluster up to a seed point and all points within an epsilon distance (the minimum distance constituting the cluster).

In other words, clustering based on the point cloud and P-Box generation proceed upon the segmentation processing. For example, an AI network which performs segmentation is used to obtain a point label from the LiDAR 120.

The present disclosure proposes a “rule-based” road surface recognition and label fusion technique to solve a ground surface recognition error problem which occurs upon segmentation. It is fine that any of various techniques, such as road surface recognition based on a slope, grid-based road surface recognition, and the other non-planar based road surface recognition, is representatively applied to the road surface recognition algorithm. However, the present disclosure proposes adopting a slope-based road surface recognition technique, if recognizing a road surface in a tunnel.

For reference, semantic segmentation is a task for attaching a unique class label to respective points in the point cloud generated by the LiDAR 120. The semantic segmentation in a LiDAR imaging technology is a technology for finding and using meaningful information from LiDAR data for object recognition or scene representation necessary to implement autonomous driving. There are already various semantic segmentation AI models, such as a projection-based method, a point-based method, and a sparse convolution-based method. For example, the semantic segmentation result may be the AI computation result performed together with the NVIDIA DRIVE™ AGX system by the processor 110. Via such a configuration, various colors may be added to, for example, the LiDAR point cloud image.

The LiDAR image passes through the process called post-processing after the segmentation process. The post-processing refers to converting point cloud data into a 3D map or modeling, which is information meaningful for autonomous driving. A process of finally removing noise of the LiDAR point cloud image or an error in the LiDAR point cloud image, recognizing an object, such as a vehicle or a pedestrian, from the point cloud, and attaching and registering a unique identifier to the point cloud information if necessary is also included in the post-processing.

FIG. 2 is a flow diagram illustrating an example operation process 200 of an autonomous driving system 1000 with LiDAR recognition software architecture.

S101 indicates a process of processing optical data as packet data using a LiDAR 120. In other words, the input in S101 may be the optical data and the output in S101 may be the packet data. In S101, an operation of converting data detected by a LiDAR sensor information optical system into digital information may be performed.

In S102, packet data of a packet data point cloud may be converted into point cloud data on a sensor coordinate system. The output in S102 may be the point cloud data configured on the basis of the sensor coordinate system as the point cloud. S102 may be preferably calculated by a GPU processor. In other words, the input to S102 may be LiDAR packet data and sensor meta information.

S103 may be a process of calibrating a point cloud sensor coordinate system version to a point cloud with respect to a vehicle coordinate system, which is a procedure for removing dependency on a vehicle type or the like in object recognition. S103 may be preferably calculated by the GPU processor.

S104 may be a process of detecting an object from the point cloud based on deep learning. For example, the output in S104 may be a LiDAR data bounding box. In S104, the bounding box including heading information and the result of recognizing a class may be output over an AI network for recognizing the class. S104 may be preferably calculated by the GPU processor.

In S111, the output in S104 may be converted into P-Box information and class information derived based on deep learning. The input to S104 may include point cloud data, sensor information, and timestamp information. As a result, the output in S111 may be box information calculated based on deep learning and the result of recognizing the class (e.g., whether there is a moving object or a static object).

Meanwhile, in S105, LiDAR data may be input and output as class classification information and related score information. In other words, a class in units of points and the result of calculating the score may be output over the above-mentioned segmentation network. S105 may be preferably calculated by the GPU processor. The input to S105 may include point cloud data, sensor information, and timestamp information.

In S106, ground point classification may be performed after the LiDAR data is input. S106 may be ground point classification based on signal processing, rather than deep learning. Such a task may be performed in units of points and may be configured to perform binary classification. The input to S106 may include point cloud data, sensor information, and timestamp information.

In S107, a class for each point and the result of recognizing the ground may be input and a class and a score may be output. In other words, S107 may be understood as a process for fusing the output in S105 with the output in S106 to reinforce a ground point to ensure ground recognition performance of ultra-close range data. This may be a process in which ground data is fused by a point cloud library (PCL).

In S108, LiDAR data and class information may be input, which may be output as a cluster ID and cluster-related information (e.g., a size of a cluster, the average number of points included in the cluster, or the like). In other words, an operation of dividing the cluster using a point characteristic and distance information may be executed in S108. For example, the output in S108 may be a cluster ID assigned for each point.

In S109, LiDAR data and cluster ID information may be input and a P-Box and related class information may be output. A bounding box including a three-dimensional (3D) position, size, and heading of the P-Box and a class may be output based on signal processing. The output in S109 may be box information calculated based on signal processing and the result of recognizing the class (e.g., whether there is a moving object or a static object).

In S110, LiDAR data and cluster ID information may be input and contour information about a recognition target object may be output. The output in S110 may be the result of recognizing the contour, which is calculated based on signal processing.

In S112, meta fusion of the results in S109, S110, and S111 may be performed. In other words, in S112, the meta fusion may be performed based on the bounding box and the class information output based on the deep learning and the bounding box, the class, and the contour information obtained based on the signal processing.

In S113, a multi-object tracking ID may be generated, based on the bounding box and the class information.

For reference, in S103, main parameters may be composed of (x,y,z,r,θ,φ) in a process of converting individual sensor coordinates into common sensor coordinates and converting the common sensor coordinates into vehicle coordinates. (x,y,z) refer to magnitudes in horizontal, vertical, height directions around a 3D reference axis, respectively. (r,θ,φ) refer to a distance to point P presenting on a 3D space, an elevation, and an azimuth, respectively. (xₛₑₙₛₒᵣ, yₛₑₙₛₒᵣ, zₛₑₙₛₒᵣ, rₛₑₙₛₒᵣ, θₛₑₙₛₒᵣ, φₛₑₙₛₒᵣ) values measured by an autonomous driving sensor, for example, LiDAR 120 may be modified by Equation 1 below according to default mounting (DM), that is, a design value in common for each vehicle type in S103.

$${T}_{DM}^{S} = [ \begin{matrix}{R}_{DM}^{S} & {t}_{DM}^{S} \\ 0 & 1\end{matrix} ] \qquad 〈 Equation 1 〉$$

$${T}_{SC}^{DM} = [ \begin{matrix}{R}_{SC}^{DM} & {t}_{SC}^{DM} \\ 0 & 1\end{matrix} ] \qquad 〈 Equation 2 〉$$

$${T}_{OC}^{DM} = [ \begin{matrix}{R}_{OC}^{DM} & {t}_{OC}^{DM} \\ 0 & 1\end{matrix} ]$$

$${T}_{yaw}^{DM} = [ \begin{matrix}{R}_{yaw}^{DM} & {t}_{yaw}^{DM} \\ 0 & 1\end{matrix} ]$$

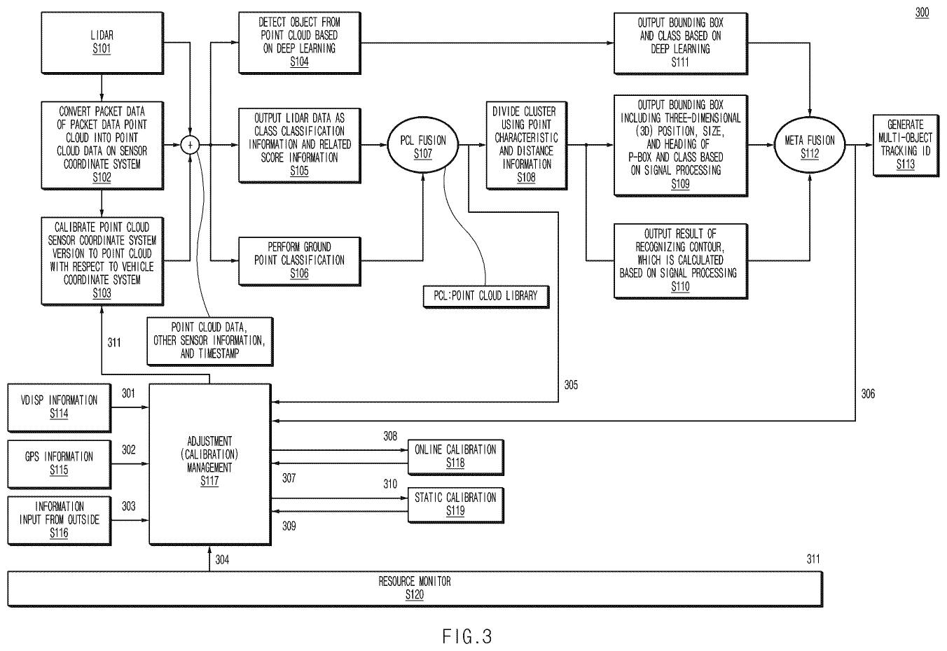

Data converted according to Equation 1 above may pass through S117 described below to obtain a (xₛₑₙₛₒᵣ, yₛₑₙₛₒᵣ, zₛₑₙₛₒᵣ, rₛₑₙₛₒᵣ, θₛₑₙₛₒᵣ, φₛₑₙₛₒᵣ) parameter set (e.g., default data or default parameter set) converted via calibration most suitable for a current road situation depending on Equation 2 above. There is an algorithm 300 of FIG. 3 in which such a calibration process is reflected in the algorithm 200 of FIG. 2.

FIG. 3 is a flow diagram illustrating the algorithm 300 for applying a calibration technology of a LiDAR sensor to an autonomous driving LiDAR recognition software architecture. A description duplicated with the steps described in FIG. 2 will be omitted.

In S114, vehicle dynamics input signal processing (VDISP) information may be delivered to a calibration manager and may be used for calibration in S117. The VDISP information may include information, such as a speed or heading about a vehicle currently loaded with an autonomous driving sensor 120, that is, a host vehicle and may have the meaning of collectively referring to various input signals associated with dynamic operation of the host vehicle in the present disclosure. Information represented as 301 of FIG. 3 may correspond to the VDISP information.

In S115, global positioning system (GPS) information may be delivered to the calibration manager and may be used for the calibration in S117. For example, information about whether a current driving environment is a highway or an urban center may be included in the GPS information. Information represented as 302 of FIG. 3 may correspond to the GPS information.

In S116, information input from the outside may be delivered to the calibration manager and may be used for the calibration in S117. In other words, any calibration value received from an AI module or a user may be included in the information input from the outside. Information represented as 303 of FIG. 3 may correspond to the information input from the outside.

In S120, resource information may be delivered to the calibration manager by a resource manager and may be used for the calibration in S117. This is because the AI module should know available computing power or a resource state, such as a memory resource, if S117 is executed. Particularly, the resource situation may be information necessary to determine whether a requirement for online calibration which will be described below is satisfied. Information represented as 304 of FIG. 3 may correspond to the resource information.

The output in S107 may be delivered to the calibration manager as the segmentation result and may be used for the calibration in S117. Information represented as 305 of FIG. 3 may correspond to the output.

The meta fusion result in S112 may also be delivered to the calibration manager and may be used for the calibration in S117. The meta fusion result may include information about an object which is moving or stopping in the current driving environment. Information represented as 306 of FIG. 3 may correspond to the meta fusion result.

In S118, online calibration may be executed and the result may be delivered to the calibration manager to be used for the calibration in S117. Information represented as 307 of FIG. 3 may correspond to the result. A parameter, a confidence score, or the like associated with the online calibration may be included in the result.

As shown in FIG. 3, one of the outputs in S117 may be fed back for S118, which may ON/OFF command information for commanding whether to execute S118. Information represented as 308 of FIG. 3 may correspond to the output.

In S119, static calibration may be executed and the result may be delivered to the calibration manager to be used for the calibration in S117. Information represented as 309 of FIG. 3 may correspond to the result and may include a parameter associated with static calibration.

As shown in FIG. 3, one of the outputs in S117 may be fed back for S119. An updated value of a static calibration parameter necessary to execute S119 may be fed back. Information represented as 310 of FIG. 3 corresponds to the output.

In S117, a calibration process of LiDAR 120 necessary for an autonomous vehicle may be performed. All the pieces of information 301 to 310 mentioned above may be used in the calibration process. In S117, a calibration parameter suitable for a current operation condition between the result of the static calibration and the result of the online calibration may be output and a prerequisite for online calibration may be checked using the resource situation, the VDISP information, or the like which is mentioned above. Furthermore, in S117, it is possible to update a parameter for static calibration using confidence about calibration and it is possible to output any calibration value desired by the user, if there is an external input. As a result, the result of executing S117 may be provided to S103 as a final calibration parameter. Information represented as 311 of FIG. 3 corresponds to the result.

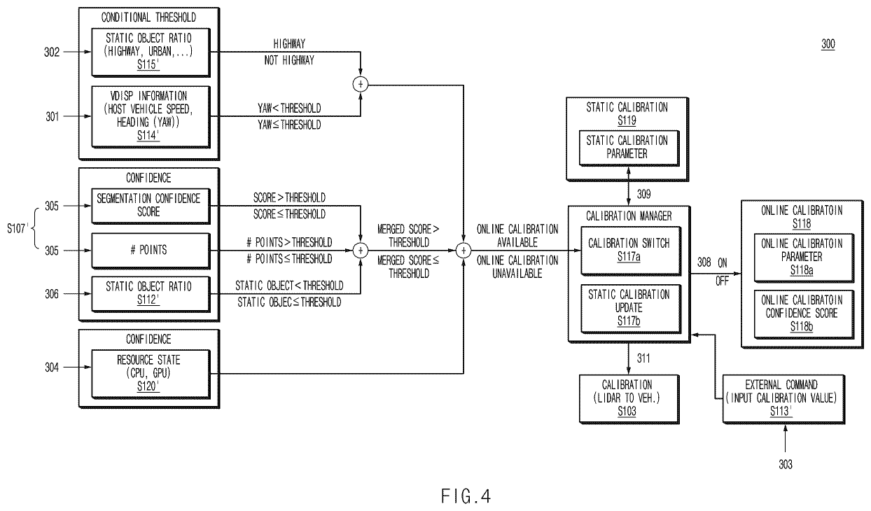

FIG. 4 is a flow diagram on a calibration part of the algorithm 300 for applying a calibration technology of a LiDAR sensor to an autonomous driving LiDAR recognition software architecture. A description duplicated with details described in FIGS. 2 and 3 will be omitted.

S114′ shows a state immediately before information 301 of FIG. 3 is previously input and is then delivered to S117. Herein, host vehicle speed, heading, and yaw angle information may be included as VDISP information.

S115′ shows a state immediately before information 302 of FIG. 3 is previously input and is then delivered to S117. Information about driving environment recognition may be included in information 302. Information about whether a current driving environment is a highway or an urban center may be delivered for S117.

S107′ shows a state immediately before information 305 of FIG. 3 is previously input and is then delivered to S117. A segmentation confidence score, point number information, or the like may be included in information 305.

S112′ shows a state immediately before information 306 of FIG. 3 is previously input and is then delivered to S117. For example a ratio at which a static object is occupied may be included in information 306.

S120′ shows a state immediately before information 304 of FIG. 3 is previously input and is then delivered to S117. A resource state of a processor 110, particularly, a CPU, and a GPU may be provided for S117.

It may be checked in FIG. 4 that information 309 described above in FIG. 3 is delivered from S119 to S117.

Information 308 delivered from S117 to S118 may be used for computation (e.g., determination) of an online calibration parameter (e.g., S118a) and computation (e.g., determination) of an online calibration confidence score (e.g., S118b). The online calibration parameter and the online calibration confidence score may be stored in a memory (e.g., a predetermined area of the memory such as a buffer).

Information 311 provided from S117 to S103 may be a final calibration parameter as described above, which may be used to switch LiDAR reference coordinates to a vehicle coordinate system. To this end, in S117, a calibration switch (S117a) may occur to select optimal coordinates and a static calibration-related parameter may be updated (e.g., S117b).

S113′ shows a state immediately before information 303 of FIG. 3 is previously input and is then delivered to S117. A calibration value randomly input by a user may be included in information 303.

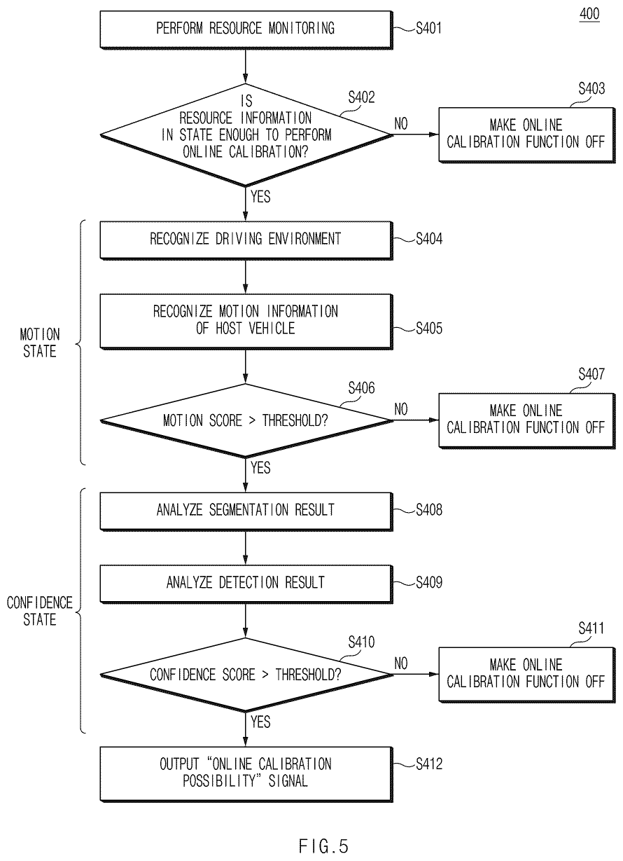

FIG. 5 is a flowchart illustrating an example process 400 of performing calibration management. In other words, there is FIG. 5 in which an algorithm performed in S117 is more detailed.

Referring to FIG. 5, in S401, resource monitoring may be performed. This may be a process corresponding to S120 of FIG. 3. In S401, current resource information of a system may be integrated and monitored. In S402, the resource information may be checked to be in a state enough to perform online calibration.

Upon NO determination in S402, it may move to S403 to make an online calibration function OFF and may enter a waiting state again due to a lack of resources and may subsequently wait until resources are sufficient.

If the resources are sufficient, in S404, a driving environment may be recognized. A current road environment of a vehicle may be determined using a global positioning system (GPS), navigation information, or the like. For example, it may be determined whether the vehicle is driving on a highway, a tunnel, an underground road, a typical urban center, an alley, or the like. The obtained driving environment information may be used to calculate a motion score and a confidence score.

In S405, motion information of a host vehicle may be recognized. The motion information (e.g., a speed, a heading, or the like) of the host vehicle may be calculated using VDISP or the like. The motion information of the host vehicle may be combined with the driving environment information obtained in S404 to be used to calculate the motion score. For example, the motion score may be configured to be set to be smaller in an urban environment than a highway even at the same quick speed (e.g., 70 km/h).

In S406, it may be determined whether the calculated motion score is greater than certain criteria. If the motion score is less than the criteria, it may move to S407 to enter the waiting state.

In S408 and S409 to which it moves upon YES determination in S406, the motion information and the environmental information, which are obtained above, may be used. First of all, in the analysis of segmentation result in S408, label information and a score for each point may be received from a segmentation output layer. It may be reflected in a confidence score using the number (or a ratio) of ground points, the number (or a ratio) of noise points, class confidence, or the like, which has an influence on performance of online calibration. For example, the confidence score may be set to be small, if the number of ground points is insufficient to detect the ground, and the confidence score may be set to be small, even if the ratio of noise points is large.

If the detection result is analyzed in S409, the result of recognizing a moving object and a static object may be received from an object recognition information output layer. It may be reflected in the confidence score using a ratio between a moving object (or a point) and a static object (or a point). For example, because online calibration is performed by inversely tracking motion of the static object, the less the number of static objects, the smaller the confidence score may be set to be. As another example, there are more dynamic objects, because there is a risk of error in calibration, a score may be set to be small.

In S410, results in S404, S405, S408, and S409 may be fused to calculate the fused result as a final confidence score. If the confidence score is greater than a reference threshold, it may move to S412 to output an “online calibration possibility” signal. If the confidence score is less than or equal to the threshold, it may move to S411 to enter the waiting state.

Meanwhile, depending on the executed environment or if necessary, at least some of S401 to S412 may be executed in parallel or sequentially.

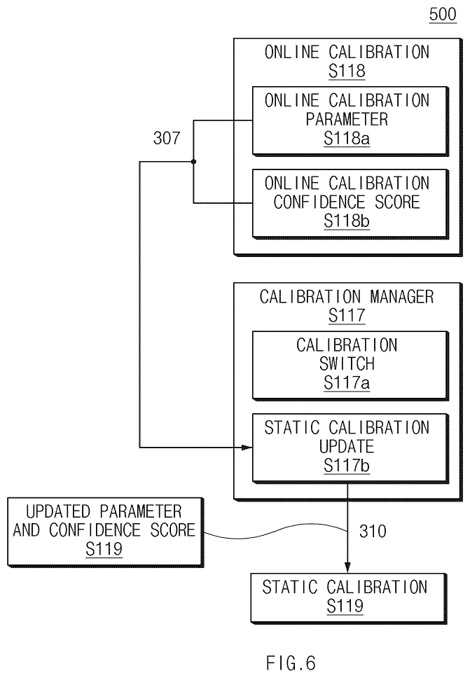

FIG. 6 is a flowchart illustrating an example process 500 of updating a static calibration value. FIG. 6 is a drawing for describing in detail S119 of FIGS. 3 and 4.

Referring to FIG. 6, in an online calibration step in S118, a parameter result value (e.g., S118a) and confidence information (e.g., S118b) may be transmitted for processing according to S117. In S117, data transmitted in S118 may be stored in a dedicated buffer (not shown) separately provided. If the buffer (not) is full or at a time when online calibration is OFF (e.g., an ON/OFF switch according to S117a), optimal parameter values may be updated (e.g., S117b) to empty the buffer. Of course, the optimal parameter value may be provided for S119 as the updated parameter and confidence score.

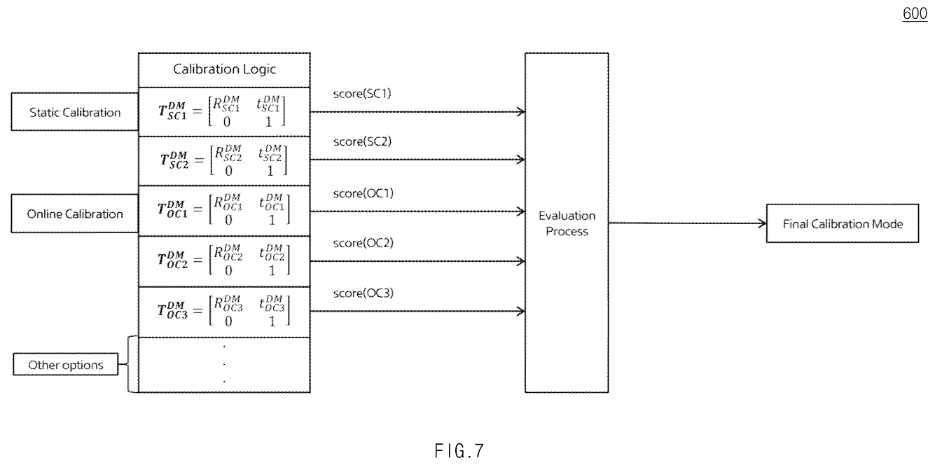

FIG. 7 is a block diagram illustrating an example process 600 of verifying calibration and evaluating the result in real time. According to FIG. 7, a calibration score may be calculated based on a threshold, a confidence score, or the like. The calibration score may be used to evaluate performance of a system according to FIG. 3.

In some implementations, a calibration value may be fixed based on a parameter (or static calibration) specified for the first time, if software for object recognition is executed, and calibrating a calibration value may file while driving. This may be seen as a software architecture without regard to expandability for applying additional calibration logic, for example, supporting calibration online.

In view of the above problem in at least some implementations, the present disclosure is able to adaptively apply a calibration parameter to select a calibration mode most suitable for a current road. For example, because the accuracy of online calibration is large in a highway, it is possible to control autonomous driving based on the online calibration.

Furthermore, the present disclosure may flexibly change the calibration mode while driving. For example, at least in some implementations, autonomous driving operations may be disengaged if a problem occurs in online calibration. However, the present disclosure is able to change the calibration mode to a static calibration mode to continuously perform autonomous driving, although a problem occurs in online calibration.

Furthermore, the present disclosure may ensure stability and accuracy via a continuous update of the static calibration parameter.

As described above, some implementations use an end-of-line (EOL) calibration value, which is a fixed value. However, the present disclosure may use the value updated by the static calibration. In addition, the present disclosure may ensure resource connectivity with another logic based on an architecture design considering CPU/GPU resources and may introduce a design scheme considering an external driving situation, motion information of a host vehicle, or confidence of calibration to more ensure accuracy. The present disclosure is able to ensure calibration performance robust to several situations using a logic output (e.g., the number of ground points, a ratio of static objects, or the like) and be expanded and applied to various calibration algorithms using the logic output. For example, the present disclosure is able to perform calibration based on the ground, calibration based on a target, calibration based on motion, or the like.

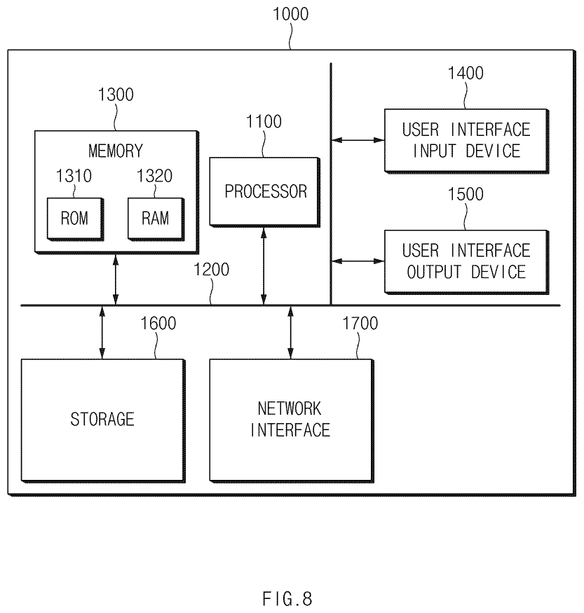

FIG. 8 is a block diagram illustrating an example computing system 1000 for autonomous vehicle control and object recognition computation.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described herein may be directly implemented with a hardware module, a software module, or a combination of the hardware module and the software module, which is executed by the processor 1100. The software module may reside on a storage medium (e.g., the memory 1300 and/or the storage 1600) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a system for recognizing an object by means of a vehicle loaded with an artificial intelligence (AI) module and an autonomous driving sensor may include a processor loaded with the AI module including a calibration module for recognizing an object presenting in a surrounding environment and a driving environment from data input from the autonomous driving sensor and a memory storing the input data. The AI module may in parallel or sequentially execute receiving default data necessary for calibration from the autonomous driving sensor or the vehicle and receiving information about a resource state of the processor or the memory, calculating a motion score and a confidence score based on driving environment information and motion information of the vehicle, adjusting the confidence score using the result of segmenting the data input from the autonomous driving sensor and the result of recognizing a moving object or a static object presenting in the driving environment, and determining whether to execute online calibration based on the adjusted confidence score.

The adjusting of the confidence score may include a process of additionally reflecting the driving environment information and the motion information in the result of segmenting the data.

The adjusting of the confidence score may include a process of additionally reflecting the driving environment information and the motion information in the result of recognizing the moving object or the static object.

The driving environment information may be obtained using a global positioning system (GPS) or a navigation device in the vehicle.

The determining of whether to execute the online calibration may include a process of entering a waiting state without executing the online calibration, if the resource state is less than a first reference value.

The motion score may be variably calculated according to a proportional relationship or an inverse proportional relationship between the driving environment information and the motion information.

The determining of whether to execute the online calibration may include a process of entering a waiting state without executing the online calibration, if the motion score is less than a second reference value.

The determining of whether to execute the online calibration may include a process of entering a waiting state without executing the online calibration, if the confidence score is less than a third reference value.

The determining of whether to execute the online calibration may include a process of storing an online calibration parameter and an online calibration confidence score obtained by the online calibration in a certain storage space, if determining to execute the online calibration.

The determining of whether to execute the online calibration may include a process of updating an optimal parameter value at a time point when the certain storage space is full and emptying the full certain storage space.

A method for recognizing a surrounding environment and an object from data of a vehicle loaded with an artificial intelligence (AI) module and an autonomous driving sensor and adjusting coordinates necessary for object recognition may include the AI module including receiving default data necessary for calibration from the autonomous driving sensor or the vehicle and receiving information about a resource state of a processor or a memory, calculating a motion score and a confidence score based on driving environment information and motion information of the vehicle, adjusting the confidence score using the result of segmenting data input from the autonomous driving sensor and the result of recognizing a moving object or a static object presenting in the driving environment, and determining whether to execute online calibration based on the adjusted confidence score.

In some implementations, a calibration value may be fixed based on a parameter (or static calibration) specified for the first time, if software for object recognition is executed, and may fail to calibrate a calibration value while driving. This may be seen as a software architecture without regard to expandability for applying additional calibration logic, for example, supporting calibration online.

In view of the above problem found in some implementations, the present disclosure is able to adaptively apply a calibration parameter to select a calibration mode most suitable for a current road. For example, because the accuracy of online calibration is large in a highway, it is possible to control autonomous driving based on the online calibration.

Furthermore, the present disclosure may flexibly change the calibration mode while driving. For example, at least in some implementations, an autonomous driving operation may stop if a problem occurs in online calibration. However, the present disclosure is able to change the calibration mode to a static calibration mode to continuously perform autonomous driving, although a problem occurs in online calibration.

Furthermore, the present disclosure may ensure stability and accuracy via a continuous update of the static calibration parameter.

As described above, some implementations may use an end-of-line (EOL) calibration value which is a fixed value. However, the present disclosure may use the value updated by the static calibration. In addition, the present disclosure may ensure resource connectivity with another logic based on an architecture design considering CPU/GPU resources and may introduce a design scheme considering an external driving situation, motion information of a host vehicle, or confidence of calibration to more ensure accuracy. The present disclosure is able to ensure calibration performance robust to several situations using a logic output (e.g., the number of ground points, a ratio of static objects, or the like) and be expanded and applied to various calibration algorithms using the logic output. For example, the present disclosure is able to perform calibration based on the ground, calibration based on a target, calibration based on motion, or the like.

In addition, those skilled in the air may understand various effects other than the effects described above from the present disclosure, via the detailed description of the present disclosure and the accompanying drawings.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the example embodiment(s) of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus of a vehicle, the apparatus comprising:
a processor; and
a memory storing at least one instruction that is configured, when executed by the processor, to cause the apparatus to:
receive, from a sensor of the vehicle, sensor data associated with an object that is present in a surrounding environment of the vehicle;
store, in the memory, the sensor data;
receive, from the vehicle:
a set of parameters for calibrating a coordinate system for object recognition, and
information about a resource state of at least one of the processor or the memory;
determine, based on driving environment information and motion information of the vehicle, a motion score and a confidence score;
adjust the confidence score based on a result of segmenting the sensor data and a result of recognizing the object;
execute, based on the adjusted confidence score, online calibration of the coordinate system for object recognition; and
control, based on the calibrated coordinate system for object recognition, an autonomous driving operation of the vehicle.

2. The apparatus of claim 1, wherein the least one instruction is configured, when executed by the processor, to cause the apparatus to adjust the confidence score by:
segmenting the sensor data based on the driving environment information and the motion information.

3. The apparatus of claim 1, wherein the least one instruction is configured, when executed by the processor, to cause the apparatus to adjust the confidence score by:
recognizing the object based on the driving environment information and the motion information.

4. The apparatus of claim 1, wherein the least one instruction is configured, when executed by the processor, to further cause the apparatus to:
receive, via a global positioning system (GPS) or a navigation device in the vehicle, the driving environment information.

5. The apparatus of claim 1, wherein the least one instruction is configured, when executed by the processor, to further cause the apparatus to determine whether to execute the online calibration by entering a waiting state without executing the online calibration, based on the resource state being less than a reference value.

6. The apparatus of claim 1, wherein the least one instruction is configured, when executed by the processor, to further cause the apparatus to:
determine the motion score based on a proportional relationship or an inverse proportional relationship between the driving environment information and the motion information.

7. The apparatus of claim 1, wherein the least one instruction is configured, when executed by the processor, to further cause the apparatus to determine whether to execute the online calibration by:
entering a waiting state without executing the online calibration, based on the motion score being less than a reference value.

8. The apparatus of claim 1, wherein the least one instruction is configured, when executed by the processor, to further cause the apparatus to determine whether to execute the online calibration by:
entering a waiting state without executing the online calibration, based on the confidence less than a reference value.

9. The apparatus of claim 1, wherein the least one instruction is configured, when executed by the processor, to cause the apparatus to execute the online calibration by:
storing, in a buffer of the memory, an online calibration parameter and an online calibration confidence score that are obtained for the online calibration.

10. The apparatus of claim 9, wherein the least one instruction is configured, when executed by the processor, to cause the apparatus to execute the online calibration by:
updating, based on the buffer being full, a parameter value associated with the buffer to empty the buffer.

11. A method performed by an apparatus of a vehicle, the method comprising:
receiving, from a sensor of the vehicle, sensor data associated with an object that is present in a surrounding environment of the vehicle;
receiving, from the vehicle:
a set of parameters for calibrating a coordinate system for object recognition, and
information about a resource state of at least one of a processor of the vehicle or a memory of the vehicle;
determining, based on driving environment information and motion information of the vehicle, a motion score and a confidence score;
adjusting the confidence score based on a result of segmenting the sensor data and a result of recognizing the object;
executing, based on the adjusted confidence score, online calibration of the coordinate system for object recognition; and
controlling, based on the calibrated coordinate system for object recognition, an autonomous driving operation of the vehicle.

12. The method of claim 11, wherein the adjusting of the confidence score comprises:
segmenting the sensor data based on the driving environment information and the motion information.

13. The method of claim 11, wherein the adjusting of the confidence score comprises:
recognizing the object based on the driving environment information and the motion information.

14. The method of claim 11, further comprising:
receiving, via a global positioning system (GPS) or a navigation device in the vehicle, the driving environment information.

15. The method of claim 11, further comprising determining whether to execute the online calibration by:
entering a waiting state without executing the online calibration, based on the resource state being less than a reference value.

16. The method of claim 11, further comprising:
determining the motion score based on a proportional relationship or an inverse proportional relationship between the driving environment information and the motion information.

17. The method of claim 11, further comprising determining whether to execute the online calibration by:
entering a waiting state without executing the online calibration, based on the motion score being less than a reference value.

18. The method of claim 11, further comprising determining whether to execute the online calibration by:
entering a waiting state without executing the online calibration, based on the confidence score being less than a reference value.

19. The method of claim 11, wherein the executing of the online calibration comprises:
storing, in a buffer of the memory, an online calibration parameter and an online calibration confidence score that are obtained for the online calibration.

20. The method of claim 19, wherein the executing of the online calibration comprises:
updating, based on the buffer being full, a parameter value associated with the buffer to empty the buffer.
